(19) United States
(12) Patent Application Publication
(10) Pub. No.: US 2007/0082245 A1
(43) Pub. Date: Apr. 12, 2007

(54) Evaporative cooling system for fuel cell systems using cathode product water

(76) Inventor: Volker Druenert, Russelsheim (DE)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/248,518

(22) Filed: Oct. 12, 2005

(51) Int. Cl. H01M 8/04

(52) U.S. Cl. 429/26; 429/34

(57) ABSTRACT

A fuel cell system including a fuel cell stack that employs a thermal sub-system having a specialized radiator. The cooling fluid from the fuel cell stack is directed through the radiator to remove or dissipate waste heat before the cooling fluid is returned to the stack. The radiator includes a selectively permeable wall that allows liquid water or water vapor to selectively permeate therethrough to the outside of the radiator, where it is evaporated to increase the cooling ability of the radiator. A water separator separates water from the cathode exhaust of the fuel cell stack, which is used to replenish water in the cooling fluid that is evaporated through the radiator wall.

### BACKGROUND OF THE INVENTION

1. Field of the Invention

This invention relates generally to a thermal sub-system for a fuel cell system and, more particularly, to a thermal sub-system for a fuel cell system that employs a radiator having a selectively permeable wall to allow water in a cooling fluid flowing through the radiator to permeate through the wall and be evaporated to increase the cooling ability of the radiator, where the water separated from the cathode exhaust is used to replenish the evaporated cooling fluid water.

2. Discussion of the Related Art

Hydrogen is a very attractive fuel because it is clean and can be used to efficiently produce electricity in a fuel cell. A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work can act to operate a vehicle.

Proton exchange membrane fuel cells (PEMFC) are a popular fuel cell for vehicles. The PEMFC generally includes a solid polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA).

Several fuel cells are typically combined in a fuel cell stack to generate the desired power. For the automotive fuel cell stack mentioned above, the stack may include two hundred or more individual cells. The fuel cell stack receives a cathode reactant gas, typically a flow of air forced through the stack by a compressor. Not all of the oxygen is consumed by the stack and some of the air is output as a cathode exhaust gas that may include liquid water and/or water vapor as a stack by-product. The fuel cell stack also receives an anode hydrogen reactant gas that flows into the anode side of the stack. Further, flow channels are provided for a cooling fluid that flows through the fuel cell stack to maintain a thermal equilibrium.

It is necessary that a fuel cell operate at an optimum relative humidity and temperature to provide efficient stack operation and durability. A typical stack operating temperature for automotive applications is between 60°-80° C. The stack temperature provides the relative humidity within the fuel cells in the stack for a particular stack pressure. Excessive stack temperatures above the optimum temperature may damage fuel cell components, reducing the lifetime of the fuel cells. Also, stack temperatures below the optimum temperature reduces the stack performance. Therefore, fuel cell systems employ thermal sub-systems that control the temperature within the fuel cell stack.

A typical thermal sub-system for an automotive fuel cell stack includes a radiator, a fan and a pump. The pump pumps a cooling fluid, such as water and/or glycole, through the cooling channels within the fuel cell stack where the cooling fluid collects the stack waste heat. The cooling fluid is directed from the stack to the radiator where it is cooled by ambient air either forced through the radiator from movement of the vehicle or by operation of the fan. Because of the high demand of radiator airflow to reject a large amount of waste heat to provide a relatively low temperature, the fan is usually powerful and the radiator is relatively large. The physical size of the radiator and the power of the fan have to be higher compared to those of an internal combustion engine of similar power rating because of the lower operating temperature of the fuel cell system and the fact that only a comparably small amount of heat is rejected through the cathode exhaust in the fuel cell system.

FIG. 1 is a plan view of a known fuel cell system 10 including a thermal sub-system of the type discussed above. The fuel cell system 10 includes a fuel cell stack 12 having an anode side 14 and a cathode side 16. The anode side 14 receives a hydrogen input gas on line 18 and the cathode side 16 receives an airflow on line 20 and outputs a cathode exhaust on line 22. The cathode exhaust on the line 22 is sent to an optional water separator 24 that separates the water from the cathode exhaust and provides liquid water on line 26 and a cathode exhaust gas on line 28. The separated gas may be sent to the cathode input line 20 and the separated water may be used in other sub-systems in the fuel cell system 10. If the water separator 24 is not employed in the system 10, then the cathode exhaust gas, including the water, is generally exhausted to the environment.

A water containing cooling fluid is pumped through the cooling channels in the fuel cell stack 12 and a line 32 external to the stack 12 by a pump 34. The heated cooling fluid flowing in the line 32 is pumped through a radiator 36. If required, a fan 38 can force air through the radiator 36 to cool the cooling fluid, which is then sent back to the stack 12. A coolant reservoir 40 replenishes the cooling fluid as needed. The speed of the pump 34 and the speed of the fan 38 can be controlled depending on the power output of the stack 12 and other factors to provide the desired operating temperature of the stack 12.

Because liquid water may be exhausted to the environment from the system 10, a potential drawback occurs because the discharged water may form ice on the road, and may provide other inconveniences. Because the operating temperature of the fuel cell stack 12 is relatively low, significant liquid water may sometimes be produced by the stack 12.

### SUMMARY OF THE INVENTION

In accordance with the teachings of the present invention, a fuel cell system including a fuel cell stack is disclosed that employs a thermal sub-system having a specialized radiator. A water based or water containing cooling fluid flowing through the fuel cell stack is directed through the radiator to remove or dissipate waste heat before the cooling fluid is returned to the stack. Part of the heat dissipation is provided by radiation and convection as in conventional radiators. The radiator includes a selectively permeable wall that allows liquid water to permeate therethrough to the outside of the radiator, where it is evaporated to increase the cooling ability of the radiator. A water separator separates water from the cathode exhaust of the fuel cell stack, which is used to replenish the water in the cooling fluid that has evaporated through the radiator wall.

Additional features of the present invention will become apparent from the following description and appended claims, taken in conjunction with the accompanying drawings.

### BRIEF DESCRIPTION OF THE DRAWINGS

FIG. 1 is a plan view of a fuel cell system including a thermal sub-system of a type known in the art;

FIG. 2 is a plan view of a fuel cell system employing a thermal sub-system having a radiator including a porous wall to provide evaporative cooling, according to an embodiment of the present invention; and

FIG. 3 is a broken-away, cross-sectional view of the radiation shown in FIG. 2.

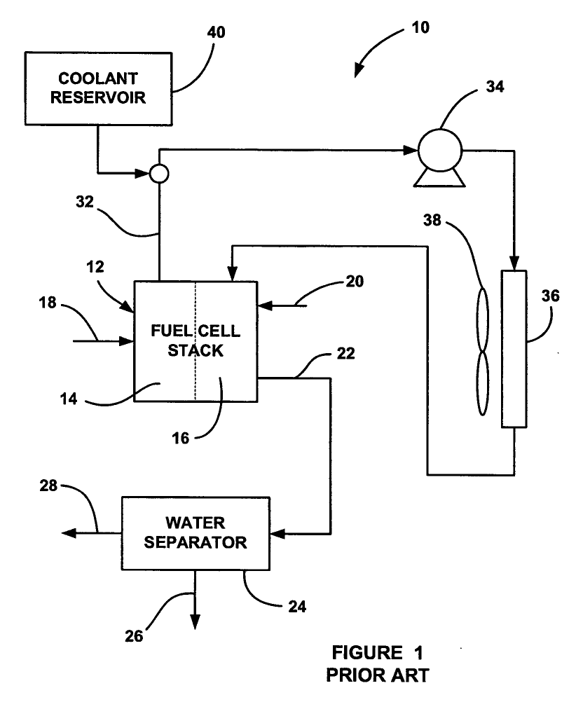

### DETAILED DESCRIPTION OF THE EMBODIMENTS

The following discussion of the embodiments of the invention directed to a thermal sub-system for a fuel cell system is merely exemplary in nature, and is in no way intended to limit the invention or its application in uses.

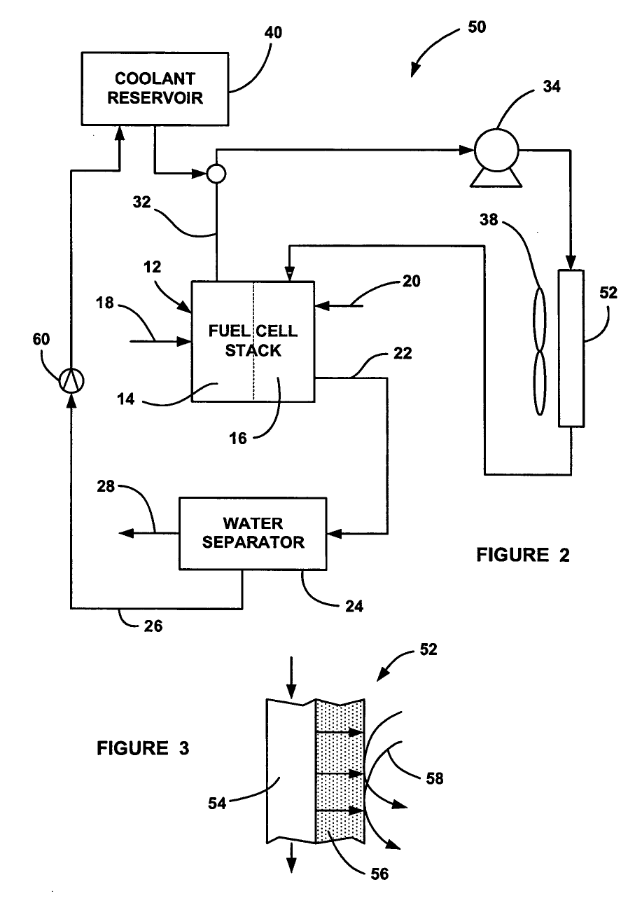

FIG. 2 is a plan view of a fuel cell system 50, according to an embodiment of the present invention, similar to the fuel cell system 10, where like elements are identified with the same reference numeral. In the system 50, the radiator 36 is replaced with a radiator 52. A cross-sectional view of a portion of the radiator 52 is shown in FIG. 3. The radiator 52 includes cooling fluid flow channels 54 and a selectively permeable wall portion 56. As discussed above, the radiator 52 receives a heated cooling fluid from the stack 12. In one non-limiting embodiment, the cooling fluid is a mixture of ethylene glycol and water of varying concentrations. However, other water based cooling fluids may be applicable to provide the desired cooling. With increasing temperature of the cooling fluid, increasing amounts of water in the cooling fluid permeate through the selectively permeable portions of the radiator wall portion 56. The glycol in the cooling fluid does not pass through the selectively permeable wall portion 56. The water that permeates through the wall portion 56 interacts with an airflow 58 either from the fan 38 or forced against the radiator 52 as a result of movement of the vehicle, or both, and evaporates at the outer side of the wall portion 56, thus providing additional cooling to the system 50. The combined process of permeation and evaporation is commonly known as pervaporation. Part of the heat dissipation from the radiator is also provided by radiation and convection as in conventional radiators.

The material of the wall portion 56 can be any material suitable for the purpose described herein, such as cross-linked poly-vinyl alcohol on a polyethersulfone support or a cross-linked Chitosan membrane. In order to support the selectively permeable, pervaporation layer or membrane, the wall portion 56 may include a porous or mesh-like metal structure of suitable shape and thickness.

In an alternate embodiment, the material of the selectively permeable wall portion 56 could have such properties where only water vapor can permeate through the wall portion 56. The same materials discussed above can be used for this embodiment for the wall portion 56. Thus, the internal evaporation of the cooling fluid from the radiator 52 increases its overall cooling capability. Therefore, the size of the radiator 52 and the fan 38 can be decreased over those radiators and fans currently used in the art.

The following equation gives the theoretical heat removed dHₑᵥₐₚₒᵣₐₜᵢₒₙ from the radiator 52 through evaporation based on the latent heat of evaporation, and thus the increased cooling power of the radiator 52, where m_{evaporated water} is the mass of the water evaporated from the radiator 52.
dHₑᵥₐₚₒᵣₐₜᵢₒₙ[kW]=m_{evaporatedwater}[kg/s]*2250[kJ/kg] (1)

Theoretical enthalpy available through evaporation for a typical radiator is given by the equation:

$$\begin{matrix}d {H}_{evaporation} \vert kW \vert = {\dot{m}}_{{H}_{2}} [ kg \text{/} s ] * 9 * {Π}_{waterseparator} * 2250 [ kJ \text{/} kg ] \\ = 0.0018 [ kg \text{/} s ] * 9 * {0.5}^{*} 2250 [ kJ \text{/} kg ] \\ = 18.5 kW\end{matrix} \qquad ( 2 )$$

As a result of the pervaporation of water from the radiator 52, the amount of molar or mass fraction of water in the cooling fluid in the thermal sub-system will steadily decrease. A cooling fluid based on a glycol-water mixture can maintain its operation requirements, such as anti-freezing capability, within a relatively large range of varying water concentrations. According to the invention, the liquid water separated by the water separator 24 on the line 26 is sent to the coolant reservoir 40 to be recycled to replenish the water supply of the cooling fluid and to keep the concentration of water in the cooling fluid in a suitable range. A check valve 60 prevents the cooling fluid in the coolant reservoir 40 from returning to the water separator 24. In the event that the amount of product water generated by the fuel cell stack 12 exceeds the amount of water evaporated through the wall portion 56, where the coolant reservoir 40 would overflow or where the desired mixing range of the water and glycol would be violated, the extra water product can be drained to the environment in the same manner as is currently done in the art.

The advantages provided by the evaporative cooling in the radiator 52 include increased cooling system performance, higher vehicle performance, a smaller radiator, a smaller front area of the vehicle, thus reducing co-efficient of drag, increased fuel cell durability and lifetime due to lower operating temperature, an increased design freedom. A reduction of liquid water emission provides the advantages of reduced annoyance, reduced formation of ice in winter on the roads, etc.

Through the design of the radiator 52 as discussed above, the advantage of a passive self regulation ability of the cooling sub-system is provided. Among other factors, the pervaporation of water through the above-mentioned materials, and thus cooling through evaporation, heavily depends on the temperature and the pressure of the cooling fluid. The higher the temperature and pressure of the cooling fluid, the higher the pervaporation rate, and thus the cooling effect. Typically, high cooling fluid temperatures and pressures occur at high fuel cell system loads. Thus, the invention as described above provides the most cooling power at high loads when required by the system. Additionally, under high loads, where water consumption through pervaporation in the radiator 52 is highest, the water production of the fuel cell stack 12 is also highest, so that the water in the cooling fluid is sufficiently replenished. This effect helps to passively self-regulate the temperature as well as the water-glycol mixture of the cooling fluid.

Hydrogen molecules are very small and are difficult to contain within an enclosed environment. It is known in the art that hydrogen can permeate through stack and plate materials within the fuel cell stack 12, especially around the plates of the stack 12. Hydrogen leaks into the cooling fluid channels where it is dissolved in the cooling fluid or is trapped in the cooling fluid as hydrogen bubbles. These hydrogen bubbles may be vented to the reservoir 40 where they accumulate. This accumulation of hydrogen within the reservoir 40 could provide a combustible source. The selectively permeable wall portion 56 would also reduce the build-up of hydrogen in the coolant loop because the hydrogen diffuses through the wall portion 56, thereby reducing the hydrogen concentration and pressure build-up in the coolant reservoir 40.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell system comprising:
a fuel cell stack providing a cathode exhaust on a cathode exhaust line, said cathode exhaust including gaseous and liquid water;
a liquid water separator receiving the cathode exhaust from the cathode exhaust line and separating the liquid water therefrom; and
a thermal sub-system including a pump, a coolant loop and a radiator, said pump pumping a cooling fluid through the coolant loop, the radiator and the fuel cell stack, said radiator including a selectively permeable wall portion that allows water in the cooling fluid flowing through the radiator to permeate therethrough and be evaporated at an external surface of the wall portion.

2. The fuel cell system according to claim 1 wherein the material of the permeable wall portion has properties that only allows water vapor to diffuse through the wall portion.

3. The fuel cell system according to claim 1 wherein the selectively permeable wall portion includes a cross-linked poly-vinyl alcohol on a polyethersulfone support.

4. The fuel cell system according to claim 1 wherein the selectively permeable wall portion includes a cross-linked Chitosan membrane.

5. The fuel cell system according to claim 1 wherein the radiator includes a support structure for supporting the selectively permeable wall portion.

6. The fuel cell system according to claim 5 wherein the support structure is a mesh-like metal structure.

7. The fuel cell system according to claim 1 wherein the permeation of the water in the cooling fluid through the wall portion is controlled by the temperature and pressure of the cooling fluid flowing through the radiator.

8. The fuel cell system according to claim 1 wherein the thermal sub-system includes a fan, said fan forcing air against the wall portion so as to increase the evaporative cooling.

9. The fuel cell system according to claim 1 wherein the thermal sub-system includes a coolant reservoir, and wherein the liquid water separated from the cathode exhaust by the water separator is sent to the coolant reservoir.

10. The fuel cell system according to claim 1 wherein the cooling fluid is a water and glycol mixture having a concentration of water and glycol in a predetermined range.

11. The fuel cell system according to claim 1 wherein the fuel cell system is on a vehicle.

12. A fuel cell system comprising:
a fuel cell stack providing a cathode exhaust on a cathode exhaust line, said cathode exhaust including gaseous and liquid water; and
a thermal sub-system including a pump, a coolant loop and a radiator, said pump pumping a cooling fluid through the coolant loop, the radiator and the fuel cell stack, said radiator including a selectively permeable wall portion that allows water in the cooling fluid flowing through the radiator to permeate therethrough and be evaporated at an external surface of the wall portion.

13. The fuel cell system according to claim 12 wherein the material of the porous wall portion has properties that only allows water vapor to disffuse through the porous wall portion.

14. The fuel cell system according to claim 12 wherein the selectively permeable wall portion includes a cross-linked poly-vinyl alcohol on a polyethersulfone support.

15. The fuel cell system according to claim 12 wherein the selectively permeable wall portion includes a cross-linked Chitosan membrane.

16. The fuel cell system according to claim 12 wherein the radiator includes a support structure for supporting the selectively permeable wall portion.

17. The fuel cell system according to claim 16 wherein the support structure is a mesh-like metal structure.

18. The fuel cell system according to claim 12 wherein the permeation of the water in the cooling fluid through the wall portion is controlled by the temperature and pressure of the cooling fluid flow through the radiator.

19. The fuel cell system according to claim 12 wherein the cooling fluid is a water and glycol mixture having a concentration of water and glycol in a predetermined range.

20. A fuel cell system for a vehicle, said system comprising:
a fuel cell stack providing a cathode exhaust on a cathode exhaust line, said cathode exhaust including gaseous and liquid water;
a liquid water separator receiving the cathode exhaust from the cathode exhaust line and separating liquid water therefrom; and
a thermal sub-system including a pump, a coolant loop, a radiator and a coolant reservoir, said pump pumping a cooling fluid through the coolant loop, the radiator and the fuel cell stack, said radiator including a selectively permeable wall portion that allows water in the cooling fluid flowing through the radiator to permeate therethrough and be evaporated at an external surface of the wall portion, and wherein the liquid water separated from the cathode exhaust by the water separator is sent to the coolant reservoir.

21. The fuel cell system according to claim 20 wherein the thermal sub-system includes a fan, said fan forcing air against the wall portion so as to increase the evaporative cooling.

22. The fuel cell system according to claim 20 wherein the material of the wall portion has properties that only allows water vapor to diffuse through the wall portion.

23. The fuel cell system according to claim 20 wherein the selectively permeable wall portion includes a cross-linked poly-vinyl alcohol on a polyethersulfone support.

24. The fuel cell system according to claim 20 wherein the selectively permeable wall portion includes a cross-linked Chitosan membrane.

25. The fuel cell system according to claim 1 wherein the radiator includes a support structure for supporting the selectively permeable wall portion.

26. The fuel cell system according to claim 25 wherein the support structure is a mesh-like metal structure.

27. The fuel cell system according to claim 20 wherein the permeation of the cooling fluid through the wall portion is controlled by the temperature and pressure of the cooling fluid flow through the radiator.

28. The fuel cell system according to claim 20 wherein the cooling fluid is a water and glycol mixture having a concentration of water and glycol in a predetermined range.
